(19) United States
(12) Patent Application Publication
(10) Pub. No.: US 2007/0130791 A1
(43) Pub. Date: Jun. 14, 2007

(54) Dehumidification process for granulated plastic materials and a plant operating in accordance with the process

(76) Inventor: Gianfranco Cattapan, Campodarsego PD (IT)

Correspondence Address: RATNERPRESTIA, P O BOX 980, VALLEY FORGE, PA, 19482-0980, US

(21) Appl. No.: 10/589,014

(22) PCT Filed: Jan. 27, 2005
(86) PCT No.: PCT/EP05/00805

§ 371 Date: Aug. 10, 2006

(30) Foreign Application Priority Data
Feb. 16, 2004 (IT) PD2004A000038

(51) Int. Cl. F26B 5/06

(52) U.S. Cl. 34/298

(57) ABSTRACT

A dehumidification process for granulated plastic materials includes a process-gas treatment step in which the moisture content of the process gas is reduced substantially and a subsequent granule-treatment step by contact with the process gas having a reduced moisture content. In the process-gas treatment step, the reduction of the moisture content of the process gas is regulated in dependence on the granules to be treated. A dehumidification plant operating in accordance with the process is also described.

This application is a U.S. National Phase Application of PCT International Application PCT/EP2005/000805.

### TECHNICAL FIELD OF THE INVENTION

The present invention relates to a dehumidification process for granulated plastics materials and to a plant operating in accordance with the process.

### BACKGROUND OF THE INVENTION

The invention is intended preferably for application in the technical field of the processing of plastics materials, in particular in the sector of the transformation of granulated plastic materials by injection and molding.

In this field, it is known to provide a step for the dehumidification of the granules immediately upstream of the injection and molding step for which the granules are required to arrive with a very low moisture level depending on the intended use of the final product.

This requirement is even more necessary for plastic materials which have marked hygroscopic properties such as, for example, plastics materials based on polyethylene terephthalate (PET).

In order to remove moisture from the granules being processed, methods are known which provide for the stripping of the moisture from the granules by contact with a process gas the moisture content of which is reduced substantially in a suitable treatment unit.

Typically, the process gas used is air which is dehumidified in the treatment unit until a dew point of the air of between −50° and −60° is reached before being put in contact with the granules to be dried.

With these low levels of moisture in the process air, the granules are dried in a suitable manner but increased production of undesired degradation products, in particular formaldehyde and acetaldehyde, has been encountered in the subsequent plasticization step.

These compounds may cause some problems of quality in the final product since they are characterized by strong and pungent odors and may migrate through the polymer matrix to its surface. In the particular case in which the final product produced from the PET granules is a bottle for containing beverages of delicate flavor, known in the art as “soft drinks” such as, for example, still water, the presence of these compounds, even in minimal quantities, may adversely affect the flavor of such beverages.

In the technical field to which the invention relates, there are also moisture-removal processes, for example, known from European patent application No. 1306635 and Japanese patent application No. 2000281825, in which, for energy-saving reasons, a capability is provided for regulation of the drying of the process air in dependence on the quantity of granules to be treated. However, this regulation is performed on the flow of air which is sent to the moisture-removal treatment and does not solve the problem set out above.

### BRIEF DESCRIPTION OF THE INVENTION

The problem underlying the present invention is that of providing a dehumidification process for granulated plastics materials and a plant operating in accordance with the process which are designed structurally and functionally to overcome the limitations set out above with reference to the prior art cited.

Within the scope of this problem, a principal object of the invention is to provide a process and a plant which have greater operative flexibility and which permit effective energy saving.

This problem is solved and this object is achieved by the dehumidification process and a plant of the present invention The dehumidification process of the present invention for granulated plastic materials includes a process-gas treatment step in which the moisture content of the process-gas is reduced substantially. The dehumidification process also includes a subsequent granular-treatment step by which the granules are contacted by the process-gas having a reduced moisture content. In the process-gas treatment step, the reduction of the moisture content of the process-gas is regulated in dependence on the granules to be treated. The plant of the present invention for dehumidification of granulated plastic materials includes a process-gas treatment unit which is arranged to reduce the moisture content of the process-gas substantially and a granular treatment unit for the treatment of the granules by the process-gas. The plant also includes regulation means for the regulation of the moisture content of the process-gas.

### BRIEF DESCRIPTION OF THE DRAWINGS

The characteristics and the advantages of the invention will become clearer from the detailed description of some preferred embodiments thereof which are illustrated by way of non-limiting example with reference to the appended drawings, in which:

FIG. 1 is a schematic view of a plant for dehumidifying granulated plastics materials, arranged for operating in accordance with the process of the present invention, and

FIG. 2 is a schematic view of a variant of the dehumidifying plant of FIG. 1.

### PREFERRED EMBODIMENTS OF THE INVENTION

In the appended drawings, a plant for dehumidifying granulated plastics materials, in particular plastics materials based on polyethylene terephthalate (PET), is generally indicated 1.

The plant 1 is arranged immediately upstream of a unit for injecting and molding the granules, which is conventional and is not shown in the appended drawings, and downstream of a system for loading the granules to be dried, which is shown only partially and indicated 2.

The plant 1 comprises a unit 3 for treating the granules coming from the loading system 2, a unit 4 for treating a process gas used for dehumidifying the granules in the treatment unit 3, as well as a circuit 5 which connects the granule-treatment unit 3 to the gas-treatment unit 4 in order to convey the process gas between them.

The granule-treatment unit 3 in turn comprises a hopper 6 at the top of which the PET granules coming from the loading system 2 are loaded, and to the bottom 6a of which the injection and moulding unit is connected.

The unit 4 for the treatment of the process gas which, in the preferred embodiment described herein is air, in turn comprises a pair of dehumidification towers 7a and 7b in which suitable molecular sieves are provided for substantially reducing the moisture content of the air passing through them.

In this context “substantial reduction” of the moisture content of the air means the production of air having a dew point below −10° C.

The process circuit 5 comprises a delivery line 8 extending between the towers 7a, 7b and the interior of the hopper 6, into which the delivery line 8 opens in order to admit the process gas to the hopper, into contact with the granules to be dried. The line 8 preferably opens in the region of the bottom 6a of the hopper so that the contact between process gas and granules takes place with a counter-current. A heater 9 is provided between the process-gas treatment units and the hopper 6, for heating the gas to a suitable temperature for admission to the hopper.

Moreover, a return line 10 for the process gas extends from the top of the hopper 6 to the towers 7a, 7b, the process gas passing through filters 11 for separating from the gas any particulates extracted from the hopper 6, and through a pair of blowers 12.

The plant 1 further comprises a regeneration circuit 15 which draws in air from the exterior and causes it to circulate inside the towers 7a, 7b and then to be readmitted to the environment. The towers 7a, 7b in fact have to alternate between operative periods and regeneration phases so that, at a given moment, only one of the two towers is operative, whilst the other is in the regeneration phase.

In order to select which of the two towers should be connected to the regeneration circuit 15 and which to the process circuit 5, the plant 1 comprises a first unit and a second unit, indicated 13 and 14, respectively, for the distribution of the process gas to the towers 7a, 7b.

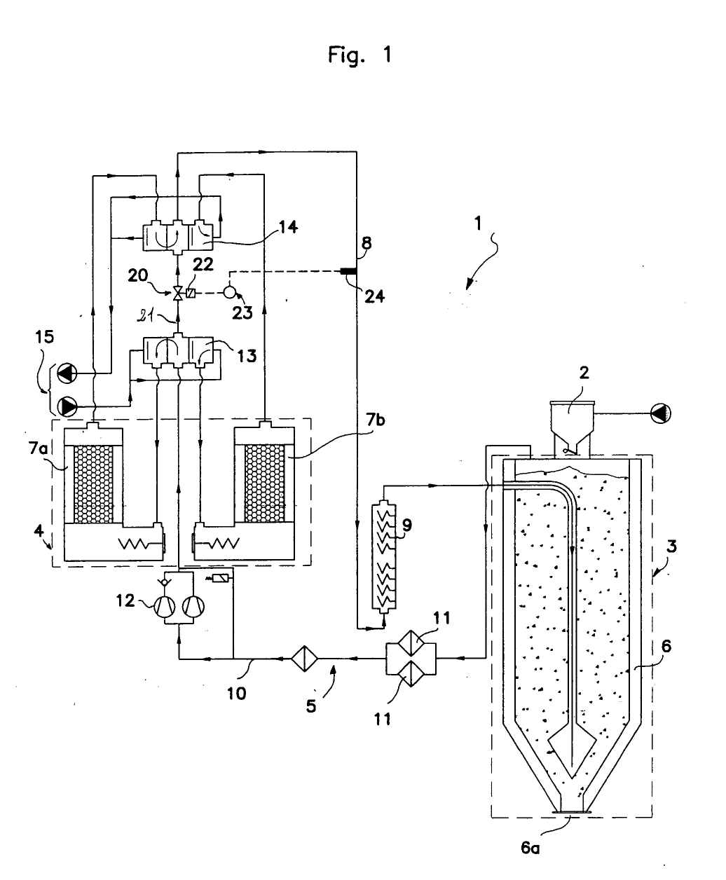

These distribution units serve to direct the process gas towards the dehumidification tower which is operative at the time in question, which is represented in FIG. 1 by the tower 7a.

According to a principal characteristic of the invention, the plant 1 comprises regulation means 20 for regulating the moisture content of the process gas.

This regulation is achieved by the bypassing of a fraction of process gas between positions upstream and downstream of the towers 7a, 7b.

The bypass means comprise a line 21 which extends directly between the first and second distribution units 13, 14 and in which a regulation valve 22, preferably of the modulation type, is mounted.

The degree of opening of the regulation valve 22 is controlled by control means 23 comprising a humidity sensor 24 disposed in the delivery line 8.

The regulation means 20 enable the moisture content of the process gas admitted to the hopper 6 to be varied since adjustment of the opening of the valve 22 causes a fraction of the process gas destined for dehumidification in the tower 7a to be passed from the distribution unit 13 directly to the distribution unit 14 without being treated.

The moisture content of the gas admitted to the hopper 6 will therefore be varied in dependence on the value of the bypassed gas fraction relative to the remaining gas fraction which is subjected to dehumidification in the tower 7a.

By virtue of the process of the invention, it is therefore possible to regulate the moisture content of the process gas in dependence on the type of granules treated in the hopper 6. This regulation is preferably performed between a minimum humidity value corresponding to a dew point of the gas of about −60° C. and a maximum value thereof which in turn corresponds to a dew point of about −10° C.

In particular, it is possible to set a relatively low humidity value corresponding to a dew point of between −50° C. and −60° C. when the granules treated in the hopper are intended for the production of containers (typically bottles) for beverages having a so-called strong flavor, particularly carbonated beverages which require containers having good gas-barrier properties.

In this case, the dehumidifying process described herein enables the desired mechanical and barrier properties to be achieved.

For the treatment of granules intended for the production of containers for beverages having a so-called delicate flavor (“soft drinks”), on the other hand, it is possible to set a relatively high humidity value for the gas admitted to the hopper, for example, corresponding to a dew point of between −10° C. and −40° C. Preference is thus given to the reduction of the formation of aldehydes which may alter the flavour of the beverage which, moreover, is not normally carbonated and therefore does not require good gas-barrier properties.

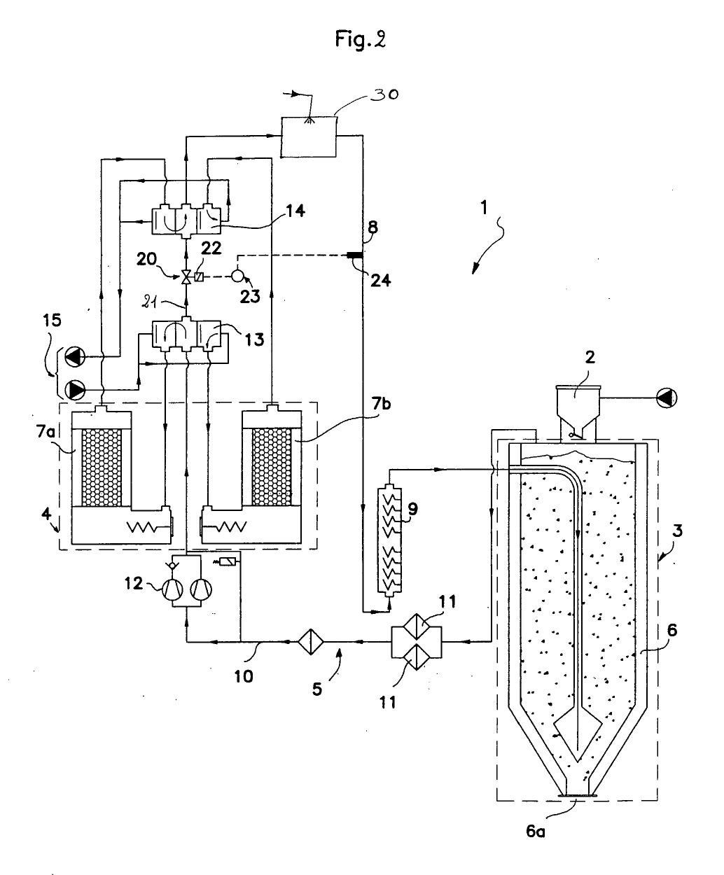

In the variant of the plant 1 shown in FIG. 2, there is provision for the insertion of a humidification unit 30 in the delivery line 8, for partially humidifying the process air.

This option may be very useful when the bypassed air fraction is very high in comparison with the air fraction treated by the towers 7a or 7b. In such cases, there may in fact be a tendency for acetaldehyde to accumulate in the process air over time in the absence of the at least partial absorption effect performed on the air by the towers 7a or 7b.

By virtue of the variant of the plant described herein, it is possible to pass through the towers 7a or 7b a fraction of process air greater than that which is strictly necessary to achieve the desired final moisture content so as to bring about the absorption of a greater quantity of acetaldehyde present in the air output from the hopper 6. Naturally, the moisture content of the process air output from the second distribution unit 14 will be less than the desired final value but it will be possible to correct that value by partially humidifying the air in the humidification unit 30.

It will be noted that the plant as a whole thus acquires an additional degree of freedom since the final degree of humidity is rendered partially independent of the fraction of air treated by the towers.

A further method of regulating the moisture content of the process air provides for the possibility of altering the efficiency of the absorption towers 7a and 7b. In particular, their regeneration parameters may be varied in order to obtain different operative performance, for example, by modifying the regeneration temperatures (minimum and maximum), or the time taken for the transition from one temperature to the other.

The present invention thus solves the problem discussed above with reference to the prior art cited, at the same time offering many further advantages, amongst which is a reduction in the running cost of the dehumidification towers which in fact treat only a fraction of the process gas.

1. A dehumidification process for granulated plastics materials, comprising a process-gas treatment step in which the moisture content of the process gas is reduced substantially, and a subsequent granule-treatment step by contact with the process gas having a reduced moisture content, and in the process-gas treatment step, the reduction of the moisture content of the process gas is regulated in dependence on the granules to be treated.

2. The process according to claim 1 in which the process gas is air.

3. The process according to claim 1 in which the reduction of the moisture content is regulated by the bypassing of a variable fraction of the process gas between positions upstream and downstream of the moisture-content reduction treatment.

4. The process according to claim 1 in which the reduction of the moisture content is regulated, downstream of the treatment to reduce the moisture content of the process gas, by means of partial humidification of the gas.

5. The process according to claim 3 in which the partial humidification is performed downstream of the recombination of the fraction of process gas which is subjected to moisture-content reduction treatment with the fraction of process gas which has bypassed that treatment.

6. The process according to claim 1 in which the moisture-content reduction is achieved by the passage of the process gas through dehumidification towers and is regulated by variation of the operative efficiency of the towers.

7. The process according to claim 6 in which the operative efficiency of the dehumidification towers is varied by modifying the regeneration phase thereof.

8. The process according to claim 1 in which the reduction of the moisture content of the process gas is regulated in dependence on the use of the final product manufactured from the granules.

9. The process according to claim 1 in which the granulated plastics material is prepared from polyethylene terephthalate (PET).

10. The process according to claim 1 in which the moisture content of the process gas can be varied between a first value at which the dew point of the gas is −10° C. and a second value at which the dew point is −60° C.

11. The process according to claim 9 in which the moisture content of the process gas is regulated in a manner such as to have a dew point of between −10° C. and −40° C. when the granules to be subjected to dehumidification are intended for the production of containers for beverages of delicate flavor and to have a dew point of between −50° C. and −60° C. when the granules to be subjected to dehumidification are intended for the production of containers for beverages of strong flavor.

12. A plant for dehumidification of granulated plastics materials comprising a process-gas treatment unit which is arranged to reduce the moisture content of the process gas substantially and a granule treatment unit for the treatment of the granules by the process gas, and the plant includes regulation means for the regulation of the moisture content of the process gas.

13. The plant according to claim 12 in which the regulation means comprise bypass means for bypassing the process-gas treatment unit to bypass a variable fraction of the process gas between positions upstream and downstream of the process-gas treatment unit.

14. The plant according to claim 13 in which the process-gas treatment unit comprises a pair of dehumidification towers of which one is connected to the granule-treatment unit and the other is connected to a regeneration circuit, as well as a first distribution unit and a second distribution unit which are disposed upstream and downstream of the dehumidification towers, respectively, and which are arranged selectively to connect one or other of the towers to the granule-treatment unit or to the regeneration circuit, the bypass means including a line extending between the first and second distribution units, a regulation valve mounted in the line, and control means for controlling the regulation valve in order to regulate the fraction of process gas to be bypassed between the distribution units in dependence on the desired moisture content of the process gas output by the gas-treatment unit.

15. The plant according to claims 12, in which the regulation means comprise a partial humidification unit disposed downstream of the process-gas treatment unit.

16. The plant according to claim 14 in which the partial humidification unit is disposed downstream of the second distribution unit.

17. The process according to claim 2, in which the reduction of the moisture content is regulated by the bypassing of a variable fraction of the process gas between positions upstream and downstream of the moisture-content reduction treatment.

18. The process according to claim 2, in which the reduction of the moisture content is regulated, downstream of the treatment to reduce the moisture content of the process gas, by means of partial humidification of the gas.

19. The process according to claim 4, in which the partial humidification is performed downstream of the recombination of the fraction of process gas which is subjected to moisture-content reduction treatment with the fraction of process gas which has bypassed that treatment.

20. The process according to claim 10 in which the moisture content of the process gas is regulated in a manner such as to have a dew point of between −10° C. and −40° C. when the granules to be subjected to dehumidification are intended for the production of containers for beverages of delicate flavor and to have a dew point of between −50° C. and −60° C. when the granules to be subjected to dehumidification are intended for the production of containers for beverages of strong flavor.

21. The plant according to claim 13, in which the regulation means comprise a partial humidification until disposed downstream of the process-gas treatment unit.

22. The plant according to claim 14, in which the regulation means comprise a partial humidification until disposed downstream of the process-gas treatment unit.

23. The plant according to claim 15, in which the partial humidification unit is disposed downstream of the second distribution unit.
